(19) United States
(12) Patent Application Publication
(10) Pub. No.: US 2019/0359504 A1
(43) Pub. Date: Nov. 28, 2019

(54) PIPING DEVICE FOR STRENGTHENING EFFECTS OF IRRADIATING FLUID

(71) Applicant: PHOENIX OPTRONICS CORP., Taoyuan City (TW)

(72) Inventor: REN-CHENG CHAO, TAOYUAN CITY (TW)

(21) Appl. No.: 16/417,871

(22) Filed: May 21, 2019

(30) Foreign Application Priority Data
May 28, 2018 (TW) 107206982

(51) Int. Cl. C02F 1/32

(52) U.S. Cl. CPC C02F 1/325; C02F 2201/3222

(57) ABSTRACT

A piping device for strengthening effects of irradiating fluid comprises a body, an irradiation module, and a transparent lid. The body is formed as a tube, and has an installation base, at least one passage, and a groove. The installation base is located inside the body. The at least one passage is located between the installation base and an inner surface of the body. The groove is disposed on the installation base, and has an opening facing one of two ends of the body. The irradiation module is mounted in the groove of the body, and has multiple light-emitting elements disposed toward the opening. The transparent lid is mounted with the opening of the groove of the body, and covers the groove.

### BACKGROUND OF THE INVENTION

### 1. Field of the Invention

The present invention relates to a piping device, and more particularly to a piping device that can irradiate fluid flowing therethrough.

### 2. Description of Related Art

Rays of different wavelengths on a spectrum may have different impacts on animals, plants, or even microorganisms. For example, a visible light at a wavelength of 450 nanometers (nm) can stimulate algae's growing, and an ultraviolet (UV) or near-UV at 200 to 405 nm may be used for sterilization. Thus, rays of different wavelengths may be applied in daily life or industries for a variety of purposes such as cultivating, inhibiting, or sterilizing organisms in fluid.

A conventional piping device for irradiating fluid comprises a transparent tube and multiple light sources. The transparent tube is straight, and the multiple light sources are disposed around the transparent tube. Fluid flowing axially through the transparent tube may thereby be radially irradiated by a specific wavelength via the multiple light sources in order to cultivate, inhibit, or sterilize organisms in the fluid. However, the fluid passes straight through the transparent tube of the conventional piping device for irradiating fluid, so irradiation time is too short to produce the effects mentioned above, and this may cause the fluid to fail to cultivate, inhibit, or sterilize the organisms.

To overcome the shortcomings, the present invention tends to provide a piping device for strengthening effects of irradiating fluid to mitigate or obviate the aforementioned problems.

### SUMMARY OF THE INVENTION

The main objective of the present invention is to provide a piping device for strengthening effects of irradiating fluid in order to prolong irradiation time, provide a variety of effects of irradiation, and thereby solve the shortcoming of the prior art.

The piping device for strengthening effects of irradiating fluid comprises a body, an irradiation module, and a transparent lid. The body is formed as a tube, and has an installation base, at least one passage, and a groove. The installation base is located inside the body. The at least one passage is located between the installation base and an inner surface of the body. The groove is disposed on the installation base, and has an opening facing one of two ends of the body. The irradiation module is mounted in the groove of the body, and has multiple light-emitting elements disposed toward the opening. The transparent lid is mounted with the opening of the groove of the body, and covers the groove.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a piping device for strengthening effects of irradiating fluid in accordance with the present invention;

FIG. 2 is a perspective view in partial section of the piping device for strengthening effects of irradiating fluid in FIG. 1;

FIG. 3 is an exploded perspective view in partial section of the piping device for strengthening effects of irradiating fluid in FIG. 1;

FIG. 4 is a front side sectional view of the piping device for strengthening effects of irradiating fluid in FIG. 1;

FIG. 5 is a side view in partial section of the piping device for strengthening effects of irradiating fluid along a line 5-5 in FIG. 4;

FIG. 6 is an operational side view in partial section of the piping device for strengthening effects of irradiating fluid along a line 6-6 in FIG. 4; and

FIG. 7 is a block diagram showing electrical connection of an irradiation module of the piping device for strengthening effects of irradiating fluid in FIG. 1.

### DETAILED DESCRIPTION OF THE PREFERRED EMBODIMENT

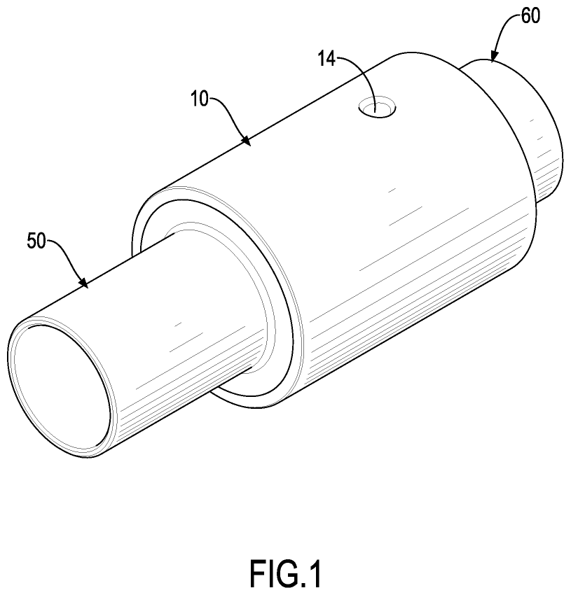

With reference to FIGS. 1 to 4, a piping device for strengthening effects of irradiating fluid comprises a body 10, an irradiation module 20, a transparent lid 30, a fixing component 40, a front connector 50, and a rear connector 60.

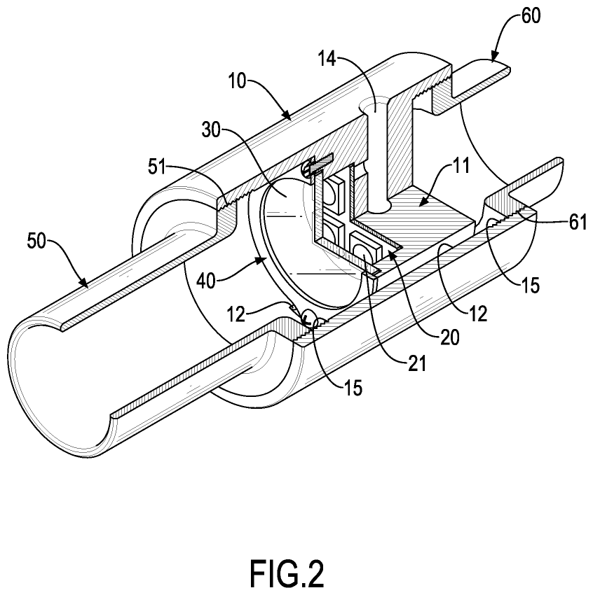

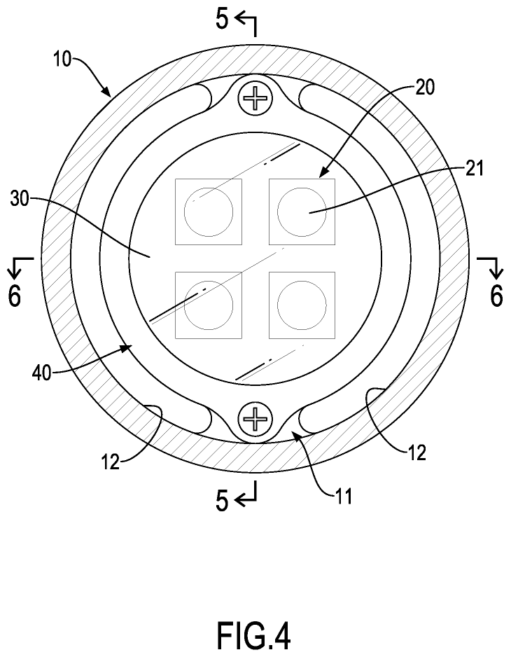

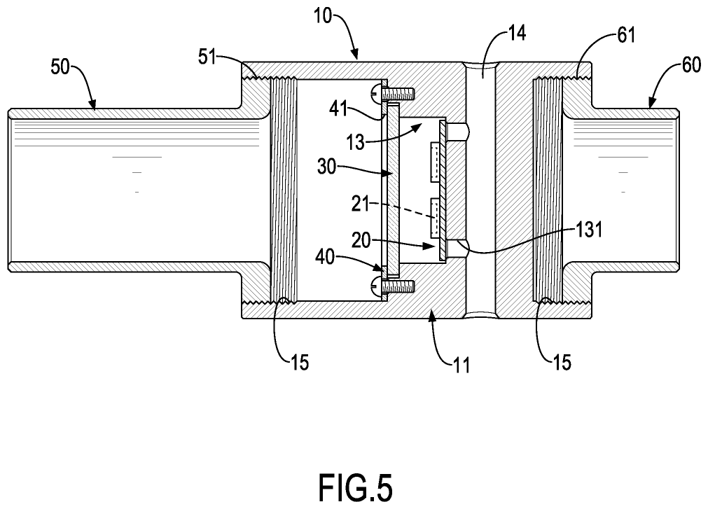

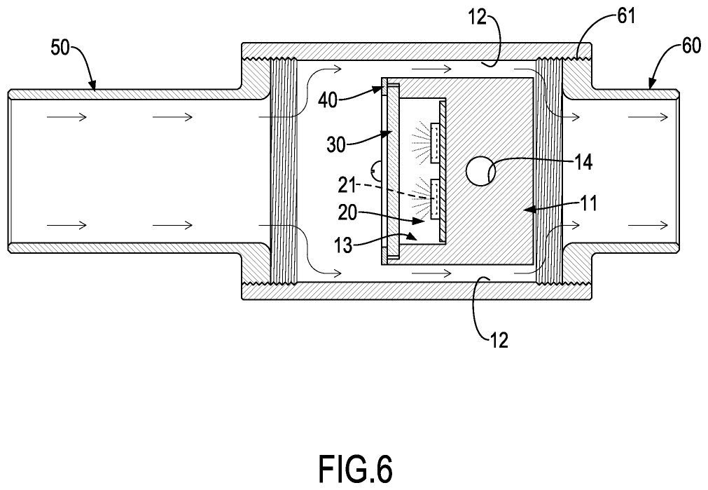

With reference to FIGS. 2 to 5, the body 10 is a tube, and has an installation base 11, at least one passage 12, a groove 13, a through hole 14, and two internal threads 15. The installation base 11 is located at a central portion of the body 10, and is connected to an inner surface of the body 10. The installation base 11 has two fixing holes 111 diametrically disposed on where the installation base 11 is connected to the inner surface of the body 10. The at least one passage 12 is disposed between the installation base 11 and the inner surface of the body 10, and communicates with two ends of the body 10. In the present invention, the body 10 has two passages 12. With reference to FIGS. 4 and 6, the two passages 12 are disposed diametrically beside the installation base 11, and each one of the passages 12 communicates with the two ends of the body 10.

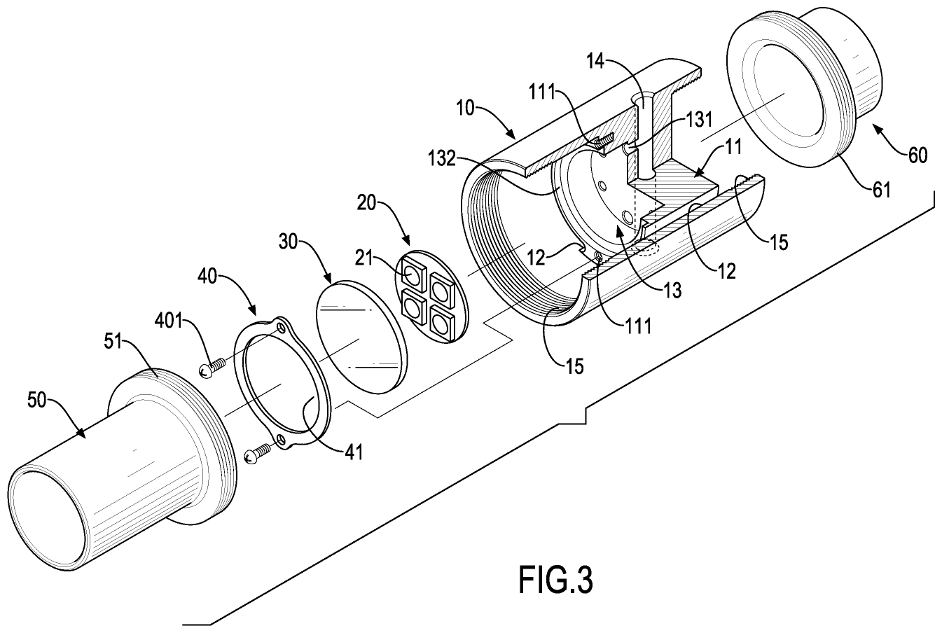

The groove 13 is disposed on a side of the installation base 11 toward one of the two ends of the body 10. The groove 13 has multiple installation holes 131 and an opening 132. The multiple installation holes 131 are axially disposed on a bottom of the groove 13. The opening 132 of the groove 13 is disposed away from the multiple installation holes 131 toward the corresponding end of the body 10. With reference to FIG. 3, the opening 132 has a diameter larger than a diameter of a part of the groove 13 near the bottom of the groove 13. Thereby the groove 13 is formed as a stepped groove. The through hole 14 is radially disposed through the body 10 via where the installation base 11 is connected to the inner surface of the body 10 and installation base 11. As a result, the through hole 14 does not communicate with the two passages 12. The through hole 14 communicates with the groove 13 via the installation holes 131 thereof. The two internal threads 15 are formed on the inner surface near the two ends of the body 10, respectively.

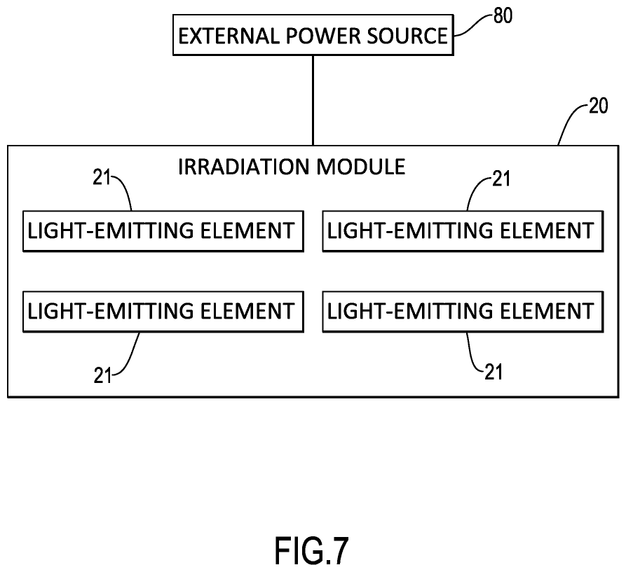

With reference to FIGS. 2, and 5 to 7, the irradiation module 20 is mounted in the groove 13, and abuts the bottom of the groove 13 of the body 10. The irradiation module 20 has multiple light-emitting elements 21 toward the opening 132 of the groove 13. The multiple light-emitting elements 21 are electrically connected to an external power source 80 via the installation holes 131 and the through hole 14. Preferably, each one of the multiple light-emitting elements 21 is a light-emitting diode (LED).

With reference to FIGS. 2, 5, and 6, the transparent lid 30 fits and seals the opening 132 of the groove 13, and covers the groove 13 and the irradiation module 20 therein to prevent each light-emitting element 21 from having a short circuit caused by fluid leakage. In the present invention, the transparent lid 30 is a circular board made of polycarbonate (PC), poly(methyl methacrylate) (PMMA), or glass, etc.

With reference to FIGS. 2, and 4 to 6, the fixing component 40 is mounted with the installation base 11. The fixing component 40 is screwed with the two fixing holes 111 of the installation base 11 via two bolts 401, and is thereby fixed to the side of the installation base 11 ahead the opening 132 of the groove 13. Furthermore, the fixing component 40 has an aperture 41 disposed therethrough and aligning with the multiple light-emitting elements 21 of the irradiation module 20. An inner diameter of the aperture 41 is smaller than an outer diameter of the transparent lid 30. As a result, the transparent lid 30 is clipped and positioned between the fixing component 40 and the installation base 11, and is thereby prevented from dropping off.

With reference to FIGS. 1, 2, 5, and 6, the front connector 50 and the rear connector 60 are connected on the two ends of the body 10, respectively. The front connector 50 has a front external thread 51. The front external thread 51 is screwed with one of the two internal threads 15 of the body 10 that the groove 13 faces. Besides, the front connector 50 extends in a lengthwise direction of the body 10, and aligns with the irradiation module 20. The rear connector 60 has a rear external thread 61 screwed with the other one of the two internal threads 15. The rear connector 60 extends in the lengthwise direction of the body 10. Moreover, a length of the front connector 50 is larger than a length of the rear connector 60.

With reference to FIG. 6, the front connector 50 and the body 10 are aligned, so fluid in the piping device continues to be irradiated from flowing into the front connector 50 to flowing into the two passages 12. The fluid is irradiated by the rays of a specific wavelength that are provided by the multiple light-emitting elements 21. A prolonged period of irradiation is thereby provided by the present invention, and the effects of cultivating, inhibiting, or sterilizing organisms in the fluid are further strengthened. After irradiated, the fluid flows out through the two passages 12 and the rear connector 60. Consequently, the piping device of the present invention utilizes axial irradiation (rather than radial irradiation) on fluid to prolong irradiation period, so as to solve the problem of the prior art.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A piping device for strengthening effects of irradiating fluid, the piping device comprising:
a body formed as a tube, and having
an installation base located inside the body;
at least one passage located between the installation base and an inner surface of the body; and
a groove disposed on the installation base, and having an opening facing one of two ends of the body;
an irradiation module mounted in the groove of the body, and having multiple light-emitting elements disposed toward the opening of the groove; and
a transparent lid mounted with the opening of the groove of the body, and covering the groove.

2. The piping device for strengthening effects of irradiating fluid as claimed in claim 1, wherein each one of the multiple light-emitting elements is a light-emitting diode.

3. The piping device for strengthening effects of irradiating fluid as claimed in claim 1, wherein the transparent lid is made of polycarbonate, poly(methyl methacrylate), or glass.

4. The piping device for strengthening effects of irradiating fluid as claimed in claim 2, wherein the transparent lid is made of polycarbonate, poly(methyl methacrylate), or glass.

5. The piping device for strengthening effects of irradiating fluid as claimed in claim 1, wherein the piping device comprises
a fixing component mounted with the installation base of the body, and having
an aperture having an inner diameter smaller than an outer diameter of the transparent lid;
wherein the transparent lid is positioned between the fixing component and the installation base.

6. The piping device for strengthening effects of irradiating fluid as claimed in claim 2, wherein the piping device comprises
a fixing component mounted with the installation base of the body, and having
an aperture having an inner diameter smaller than an outer diameter of the transparent lid;
wherein the transparent lid is positioned between the fixing component and the installation base.

7. The piping device for strengthening effects of irradiating fluid as claimed in claim 3, wherein the piping device comprises
a fixing component mounted with the installation base of the body, and having
an aperture having an inner diameter smaller than an outer diameter of the transparent lid;
wherein the transparent lid is positioned between the fixing component and the installation base.

8. The piping device for strengthening effects of irradiating fluid as claimed in claim 4, wherein the piping device comprises
a fixing component mounted with the installation base of the body, and having
an aperture having an inner diameter smaller than an outer diameter of the transparent lid;
wherein the transparent lid is positioned between the fixing component and the installation base.

9. The piping device for strengthening effects of irradiating fluid as claimed in claim 5, wherein the body has a through hole communicating with the groove, and the irradiation module is electrically connected to an external power source via the through hole.

10. The piping device for strengthening effects of irradiating fluid as claimed in claim 6, wherein the body has a through hole communicating with the groove, and the irradiation module is electrically connected to an external power source via the through hole.

11. The piping device for strengthening effects of irradiating fluid as claimed in claim 7, wherein the body has a through hole communicating with the groove, and the irradiation module is electrically connected to an external power source via the through hole.

12. The piping device for strengthening effects of irradiating fluid as claimed in claim 8, wherein the body has a through hole communicating with the groove, and the irradiation module is electrically connected to an external power source via the through hole.

13. The piping device for strengthening effects of irradiating fluid as claimed in claim 9, wherein the piping device has a front connector, and the front connector is aligned and connected with the body, and faces the irradiation module.

14. The piping device for strengthening effects of irradiating fluid as claimed in claim 10, wherein the piping device has a front connector, and the front connector is aligned and connected with the body, and faces the irradiation module.

15. The piping device for strengthening effects of irradiating fluid as claimed in claim 11, wherein the piping device has a front connector, and the front connector is aligned and connected with the body, and faces the irradiation module.

16. The piping device for strengthening effects of irradiating fluid as claimed in claim 12, wherein the piping device has a front connector, and the front connector is aligned and connected with the body, and faces the irradiation module.

17. The piping device for strengthening effects of irradiating fluid as claimed in claim 13, wherein the piping device has a rear connector, and the rear connector is aligned and connected to an end of the body away from the front connector.

18. The piping device for strengthening effects of irradiating fluid as claimed in claim 14, wherein the piping device has a rear connector, and the rear connector is aligned and connected to an end of the body away from the front connector.

19. The piping device for strengthening effects of irradiating fluid as claimed in claim 15, wherein the piping device has a rear connector, and the rear connector is aligned and connected to an end of the body away from the front connector.

20. The piping device for strengthening effects of irradiating fluid as claimed in claim 16, wherein the piping device has a rear connector, and the rear connector is aligned and connected to an end of the body away from the front connector.
